(19) United States
(12) Patent Application Publication
(10) Pub. No.: US 2010/0000575 A1
(43) Pub. Date: Jan. 7, 2010

(54) Method Of On-Line Cleaning Of A Heat Exchanger In An Ethanol Plant

(75) Inventors: D. Christopher Romer, Memphis, TN (US); Richard Hopkins, Marionville, MO (US)

Correspondence Address: AIR LIQUIDE;Intellectual Property, 2700 POST OAK BOULEVARD, SUITE 1800, HOUSTON, TX, 77056, US

(73) Assignee: Lurgi PSI, Inc., Memphis, TN (US)

(21) Appl. No.: 12/495,891

(22) Filed: Jul. 1, 2009

Related U.S. Application Data
(60) Provisional application No. 61/078,034, filed on Jul. 3, 2008.

(51) Int. Cl. B08B 9/00; B08B 3/08

(52) U.S. Cl. 134/18; 134/22.17; 134/56 R; 134/59

(57) ABSTRACT

A method for on-line cleaning of a heat exchanger in an ethanol plant, including providing heat exchanger, wherein said heat exchanger has an inlet, and an internal surface, wherein said internal surface has accumulated undesired solids; providing an antifoaming agent to said inlet, during normal operation; providing a caustic to said inlet, during normal operation, and cleaning the internal surface of said accumulated undesired solids, during normal operation is provided.

This application claims the benefit of U.S. Provisional Application No. 61/078,034, filed Jul. 3, 2008, the entire contents of which are incorporated herein by reference.

### BACKGROUND

A variety of cereal grains and other plants are grown for use as food. Major cereal grains include corn, rice, wheat, barley, sorghum (milo), millets, oats, and rye. Other plants include potatoes, cassava, and artichokes. Corn is the most important cereal grain grown in the United States. A mature corn plant consists of a stalk with an ear of corn encased within a husk. The ear of corn consists of about 800 kernels on a cylindrical cob. The kernels are eaten whole and are also processed into a wide variety of food and industrial products. The other parts of the corn plant (i.e., the stalk, leaves, husk, and cob) are commonly used for animal feed, but are sometimes processed into a variety of food and industrial products.

In more detail, the corn kernel consist of three main parts: (1) the pericarp; (2) the endosperm; and (3) the germ. The pericarp (also known as the seed coat or bran) is the outer covering of the kernel. It consists primarily of relatively coarse fiber. The endosperm is the energy reserve for the plant. It consists primarily of starch, protein (also known as gluten), and small amounts of relatively fine fiber. The germ (also known as the embryo) consists primarily of oil and a miniature plant with a root-like portion and several embryonic leaves.

Starch is stored in a corn kernel in the form of discrete crystalline bodies known as granules. Starch is a member of the general class of carbohydrates known as polysaccharides. Polysaccharides contain multiple saccharide units (in contrast to disaccharides which contain two saccharide units and monosaccharides which contain a single saccharide unit). The length of a saccharide chain (the number of saccharide units in it) is sometimes described by stating its “degree of polymerization” (abbreviated to D.P.). Starch has a D.P. of 1000 or more. Glucose (also known as dextrose) is a monosaccharide (its D.P. is 1). Saccharides having a D.P. of about 5 or less are sometimes referred to as sugars.

As mentioned above, the pericarp and endosperm of the corn kernel contain fiber. The fiber comprises cellulose, hemicellulose, lignin, pectin, and relatively small amounts of other materials. Fiber is present in relatively small amounts in the corn kernel, but is present in much greater amounts in other corn components such as the cob, husk, leaves, and stalk. Fiber is also present in other plants. The combination of cellulose and lignin is sometimes known as lignocellulose and the combination of cellulose, lignin, and hemicellulose is sometimes known as lignocellulosic biomass. As used herein, the term “fiber” (and its alternative spelling “fibre”) refers to cellulose, hemicellulose, lignin, and pectin.

A wide variety of processes have been used to separate the various components of corn. These separation processes are commonly known as corn refining. One of the processes is known as the dry milling process. In this process, the corn kernels are first cleaned and then soaked in water to increase their moisture content. The softened corn kernels are then ground in coarse mills to break the kernel into three basic types of pieces_13 pericarp, germ, and endosperm. The pieces are then screened to separate the relatively small pericarp and germ from the relatively large endosperm. The pericarp and the germ are then separated from each other. The germs are then dried and the oil is removed. The remaining germ is typically used for animal feed. The endosperm (containing most of the starch and protein from the kernel) is further processed in various ways. As described below, one of the ways is to convert the starch to glucose and then ferment the glucose to ethanol.

Fermentation is a process by which microorganisms such as yeast digest sugars to produce ethanol and carbon dioxide. Yeast reproduce aerobically (oxygen is required) but can conduct fermentation anaerobically (without oxygen). The fermented mixture (commonly known as the beer mash) is then distilled to recover the ethanol. Distillation is a process in which a liquid mixture is heated to vaporize the components having the highest vapor pressures (lowest boiling points). The vapors are then condensed to produce a liquid that is enriched in the more volatile compounds.

With the ever-increasing depletion of economically recoverable petroleum reserves, the production of ethanol from vegetative sources as a partial or complete replacement for conventional fossil-based liquid fuels becomes more attractive. In some areas, the economic and technical feasibility of using a 90% unleaded gasoline-10% anhydrous ethanol blend (“gasohol”) has shown encouraging results. According to a recent study, gasohol powered automobiles have averaged a 5% reduction in fuel compared to unleaded gasoline powered vehicles and have emitted one-third less carbon monoxide than the latter. In addition to offering promise as a practical and efficient fuel, biomass-derived ethanol in large quantities and at a competitive price has the potential in some areas for replacing certain petroleum-based chemical feedstocks. Thus, for example, ethanol can be catalytically dehydrated to ethylene, one of the most important of all chemical raw materials both in terms of quantity and versatility.

### SUMMARY

The present invention is a method for on-line cleaning of a heat exchanger in an ethanol plant, including providing heat exchanger, wherein said heat exchanger has an inlet, and an internal surface, wherein said internal surface has accumulated undesired solids; providing an antifoaming agent to said inlet, during normal operation; providing a caustic to said inlet, during normal operation, and cleaning the internal surface of said accumulated undesired solids, during normal operation.

### DESCRIPTION OF PREFERRED EMBODIMENTS

In dry mill ethanol plants, where heat exchanger surfaces are used to evaporate water from the whole stillage (fermentation product with alcohol removed) or thin stillage (the fermentation product with the alcohol and most of the suspended solids removed,) fouling can occur.

Fouling is an inevitable part of the application of heat transfer surfaces to heat the organic aqueous solutions found in a dry mill ethanol plant. Fouling is the buildup of material on the heat transfer surface that reduces the ability of heat to be transferred across the surface. Whole Stillage in a dry mill ethanol plant contains all the products of fermentation as well as the components of the grain (corn, sorghum, barley, wheat, etc) that pass through the fermentation process minus the ethanol. Thin Stillage is what is left of the Whole Stillage once most of the suspended solids have been removed. When water boils off of these two solutions, a combination of organic and inorganic solids can deposit on the heat transfer surface, reducing its effectiveness.

The traditional way to clean these surfaces, is to bring part of the process off-line and use a combination of water flushes and a hot caustic CIP (Clean In Place) solution typically made up of an approximately 3 to 5 weight % sodium hydroxide solution in water heated to between about 180 to 200° F. With the equipment off-line, there will be no boiling occurring in the equipment. In a typical industrial design for the reboilers and evaporators, the CIP cleaning may occur while the system is still “in operation”, meaning that boiling is intended to continue to occur in this equipment while it is being cleaned.

In come situations, during the CIP, while not a typical plant design, the system may be designed to continue to evaporate water (from the CIP solution) thereby allowing the ethanol to continue to be removed from the beer while cleaning the reboilers. In such a design, the water will be allowed to be returned to the front end of the process while cleaning the evaporators. In the current state of the art, is CIP of the evaporator and reboiler in an ethanol plant is not possible without full automation of the CIP process.

This is typically explained by concerns regarding the common and anticipated occurrence of foaming, which causes great difficulties, including possible damage to equipment, if foaming occurs. If this foaming does occur, and is proliferated through equipment, the chief concern has been the contamination of the process streams and damage to the beer column and rectifier column by dislocation of the column internals.

The proposed solution is a procedure for the use of an antifoaming agent (a.k.a. defoamer) and visual observations by an operator, to contain foaming, thereby making possible the on-line CIP. In one embodiment of the proposed invention, a step is included prior to the introduction of caustic for circulating the antifoaming agent through the reboiler or evaporator to be cleaned. When the caustic cleaning cycle is complete, again antifoaming agent may be used to reduce the foaming that may occur as the dirty caustic solution becomes diluted.

In one embodiment of the present invention, the equipment to be added is a tote of the antifoaming agent, a hose and valve to connect to the tote, a pump to deliver the antifoaming agent, and tubing or piping with isolation valves along with connections to existing pipes to the inlets of the equipment to be cleaned. Partial automation may be possible. It is possible that a foam detecting sensor may be installed, thereby making possible a fully automated system. The antifoaming agent is typically an expensive addition to the process, and hence the visual inspection, which is a manual process, it is preferred to use only the minimum amount of antifoaming agent necessary, in order to perform the necessary cleaning a manner safe for the equipment.

What is claimed is:

1. A method for on-line cleaning of a heat exchanger in an ethanol plant, comprising;
providing heat exchanger, wherein said heat exchanger has an inlet, and an internal surface, wherein said internal surface has accumulated undesired solids,
providing an antifoaming agent to said inlet, during normal operation,
providing a caustic to said inlet, during normal operation, and
cleaning the internal surface of said accumulated undesired solids, during normal operation.

2. The method for on-line cleaning of a heat exchanger in an ethanol plant of claim 1, wherein said heat exchanger comprises an evaporator or a reboiler.

3. The method for on-line cleaning of a heat exchanger in an ethanol plant of claim 1, further comprising monitoring the cleaning and modulating the provision of antifoaming agent as necessary to reduce or eliminate foaming.

4. The method for on-line cleaning of a heat exchanger in an ethanol plant of claim 1, further comprising monitoring the cleaning as said caustic becomes diluted and modulating the provision of antifoaming agent as necessary to reduce or eliminate foaming.

5. The method for on-line cleaning of a heat exchanger in an ethanol plant of claim 1, further comprising a foam detecting sensor in said heat exchanger.

6. The method for on-line cleaning of a heat exchanger in an ethanol plant of claim 5, further comprising a control system and a control means for controlling the amount of antifoaming agent provided to the inlet, wherein said control system modulates the control means based on readings from the foam detecting sensor.

7. An apparatus for on-line cleaning of a heat exchanger in an ethanol plant, comprising;
a heat exchanger,
a tote containing antifoaming agent,
a pump to deliver said antifoaming agent to said heat exchanger
a first hose and first valve to connect said tote, said pump, and said heat exchanger,
a second hose and second valve to connect a caustic source to said heat exchanger.

8. The apparatus for on-line cleaning of a heat exchanger in an ethanol plant of claim 7, further comprising a control system, a foam detecting sensor, wherein said first valve is a control valve controlled by said control system based on input from said foam detecting sensor.
